(19) United States
(12) Patent Application Publication
(10) Pub. No.: US 2008/0230162 A1
(43) Pub. Date: Sep. 25, 2008

(54) PNEUMATIC TYRE OF THE SEMI-HOLLOW TYPE, NOTABLY FOR AGRICULTURAL MACHINERY

(75) Inventors: Denis PIOU, Villeblevin (FR); Olivier Phely, Thenisy (FR)

Correspondence Address: OBLON, SPIVAK, MCCLELLAND MAIER & NEUSTADT, P.C., 1940 DUKE STREET, ALEXANDRIA, VA, 22314, US

(73) Assignee: OTICO, Chalmaison (FR)

(21) Appl. No.: 12/049,727

(22) Filed: Mar. 17, 2008

(30) Foreign Application Priority Data
Mar. 21, 2007 (FR) 0702062

(51) Int. Cl. B60C 11/11

(52) U.S. Cl. 152/209.12

(57) ABSTRACT

This tyre (14) is of the semi-hollow type for agricultural machinery, notably for a machine comprising a roller provided with a series of tyres mounted on a horizontal tube (12). Each tyre comprises a central sleeve (26) and at least one tread portion with a dome shaped profile comprising a tread (24) connected to the sleeve (26) by two sidewalls (28, 30) so as to define a hollow annular space (32) of reduced cross section relative to the cross section of the dome shaped profile. It further comprises a plurality of peripheral grippers (34) formed to project from the tread (24) and distributed in the circumferential direction on the top of the dome shaped profile. Alternatively, the tyre may be fitted to an individual wheel.

The invention relates to pneumatic tyres for special uses and particularly those intended for use with agricultural equipment, particularly rollers intended for seed-drill combinations, ground preparation tools, etc.

Publication FR-A-2 763 279 in the name of the present Applicant describes a semi-hollow tyre with a dome-shaped profile for such a purpose. These tyres are intended to be threaded onto a central tube to form a roller that can be used in agricultural machinery. Alternatively, the tyre may be mounted individually between two cheeks.

These tyres are particularly suitable for agricultural rollers, which are normally pulled by a tractor, being situated behind ground working equipment, the roller optionally being followed by other working tools.

A typical application is that of rollers for seed drills in which the tractor pulls a machine formed by a combination of semi-trailed tools comprising: groundworking tools; next, the roller with its dome shaped tyres which create furrows in the ground previously prepared by the tools; then seed drills which deposit grains or seeds in the furrows formed by the passage of the roller; and finally burying tools for burying the seeds.

In other applications, the roller equipped with its dome shaped tyres is placed behind groundworking tools, for example in order to break the stubble on the ground after harvesting. In this case, the roller is not followed by tools and serves essentially to level the ground.

Alternatively a tyre of this kind with a dome shaped profile may be mounted on a rim or the like to form an individual tyre. A number of these wheels can then be combined in a selected configuration, each one being independent, so as to follow the irregularities of the ground more easily.

More precisely, the tyre adapted to these uses and described in the above-mentioned publication FR-A-2 763 279 comprises a central sleeve adapted to be fitted around a horizontal tube of the agricultural machine, and at least one rolling member with a dome shaped profile comprising a tread connected to the sleeve by two sidewalls so as to define a hollow annular space of reduced cross section relative to the cross section of the dome shaped profile.

The hollow annular space is not inflated and is able to communicate with the ambient medium via an opening passing through the thickness of the sleeve and ensuring, in particular, pressure equalisation during use. Because of the dome shape and the presence of the uninflated hollow annular space of reduced cross section, the tread of the tyre is not flattened excessively, and still retains sufficient flexibility to enable it to undergo deformation and to be self-cleaning.

Hitherto, these tyres have been produced with a smooth surface at the location of the tread and sidewalls.

However, under certain extreme conditions, the presence of a smooth surface is undesirable.

For example, on ground which is dry or slightly wet, this may lead to the formation of a smooth furrow which, under the action of the sun, may form a crust that prevents the seeds from germinating; on the contrary, it would be desirable to create a crumbly soil.

Something else that would be desirable and is not permitted by a smooth tread is to create discontinuous fracture zones in the ground, capable of catching water in the event of rain, so as to limit the run-off along the furrow, especially on sloping ground.

Finally, with very light soil or, on the contrary, on heavy and slippery soils, it may be that the roller is not rotationally driven, at least temporarily.

One of the aims of the invention is to propose a tyre of the kind mentioned above which overcomes these drawbacks while retaining the advantageous features described hereinbefore.

The invention also sets out to propose a tyre of this kind which can be used not only in the fields but also for road travel without the need to raise the roller.

For this, the tyre must be able to withstand road travel with good endurance and, on the other hand, clean itself as quickly as possible, as soon as it starts to move, in order to avoid dirtying long sections of road.

The invention proposes for this purpose a tyre of the kind defined at the beginning, as disclosed by the above mentioned publication FR-A-2 763 279. According to the invention, this tyre comprises a plurality of peripheral grippers formed to project from the tread and distributed circumferentially at the top of the dome shaped profile.

In other words, the invention proposes creating grippers on the top of the tread: when the roller moves along to form the furrows, the presence of these grippers introduces a discontinuity in the furrow, promoting the crumbling of the soil and the creation of fracture zones for catching water, as described previously.

The presence of these grippers thus increases the range of use of the tyre and hence makes it versatile for extreme conditions: very light soils, heavy and slippery soils, etc.

These grippers are preferably arranged on the tread on either side of the median plane of the tyre.

It is very advantageous for the grippers to extend, in the axial direction, from the top of the sidewalls towards the median plane of the tyre, without projecting axially from the surface of these sidewalls.

The grippers are thus perfectly compatible with the use of scrapers positioned between the tyres, as on the current smooth models: this region in fact retains the same profile, in so far as the grippers are provided on the tread of the dome shaped profile and not on the sidewalls, which will clean easily.

In one embodiment, at least some of the grippers extend to a greater dimension, forming an angle with the axis of the tyre. Their width, measured between their end closest to the top of the sidewall and their end closest to the median plane of the tyre, is thus preferably greater than their length, measured in the circumferential direction.

These grippers may be in the form of chevrons or half-chevrons, in particular, extending in the axial direction up to the level of the median plane of the tyre.

In one particular embodiment, the grippers are disposed symmetrically on either side of the median plane of the tyre.

Alternatively, in other embodiments, the grippers are disposed alternately on one side and then the other of the median plane of the tyre, with each gripper being offset from the next in the circumferential direction.

In one particular embodiment, the grippers do not extend in the axial direction up to the level of the median plane of the tyre, so as to leave a gap between them at the top of the tread.

In yet another particular embodiment, the grippers are generally lozenge-shaped or generally oblong in shape.

With this type of gripper, the tyre can be used in both directions and/or mounted in either one direction or the other, when the tyres are fitted onto the central tube of the roller.

Preferably, the short axis of the lozenge or of the oblong contour generally extends from the top of the sidewall to the median plane of the tyre, and the lozenges or oblong contours are advantageously arranged alternately on one side and then the other of the median plane of the tyre, with each gripper being offset from the next in the circumferential direction.

In these embodiments, the length of the grippers, viewed in the circumferential direction, is greater than their width, viewed between their end closest to the top of the sidewall and their end closest to the median plane of the tyre.

In another aspect the invention relates to a roller comprising a plurality of tyres as defined hereinbefore. The invention also relates to a wheel comprising a tyre as defined hereinbefore.

Some examples of the implementation of the invention will now be described, with reference to the attached drawings, in which the same reference numerals have been used from one figure to another to denote elements that are identical or functionally similar.

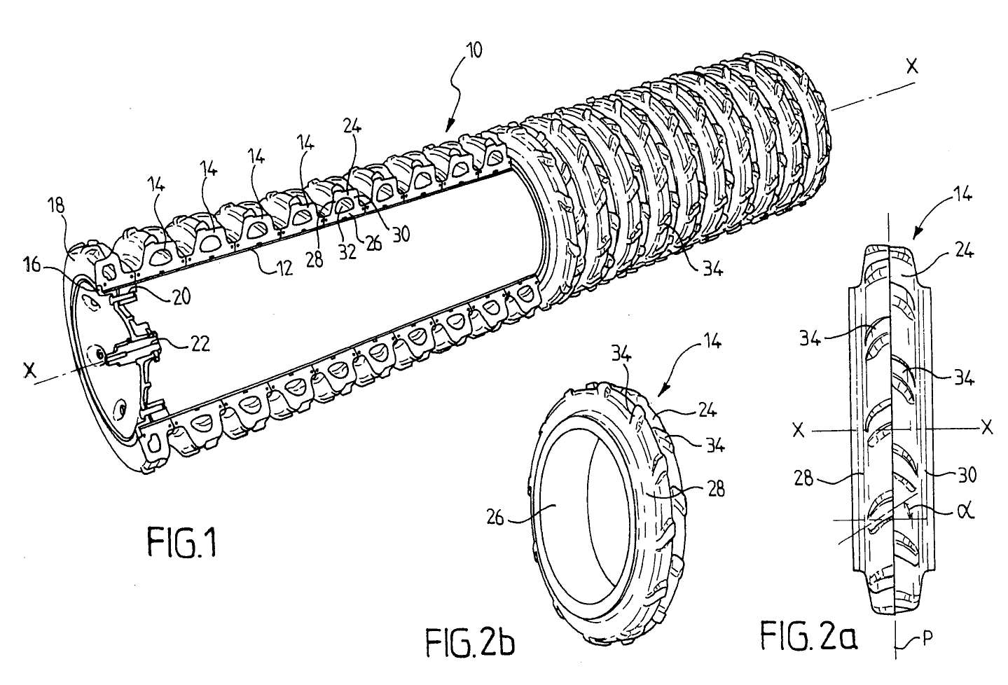

FIG. 1 is a partly cut away perspective view of a roller equipped with a set of tyres according to a first embodiment of the invention.

FIGS. 2a and 2b are views, in profile and perspective, respectively, of a tyre according to this first embodiment of the invention, shown on its own.

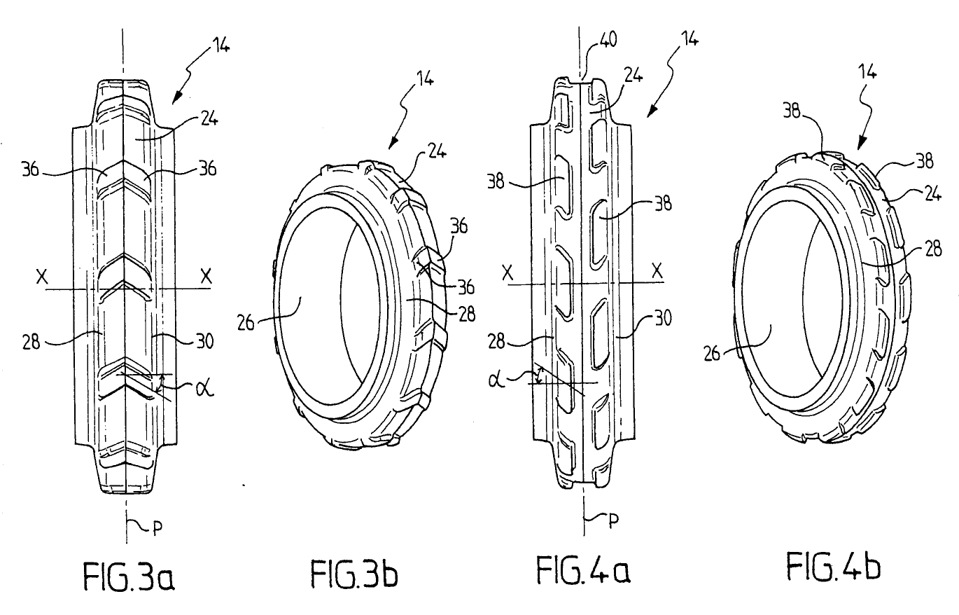

FIGS. 3a and 3b are similar to FIGS. 2a and 2b, but showing a variant of the first embodiment.

FIGS. 4a and 4b are views, in profile and perspective, respectively, of a tyre according to a second embodiment of the invention.

FIGS. 5a and 5b are views, in profile and perspective, respectively, of a tyre according to a third embodiment of the invention.

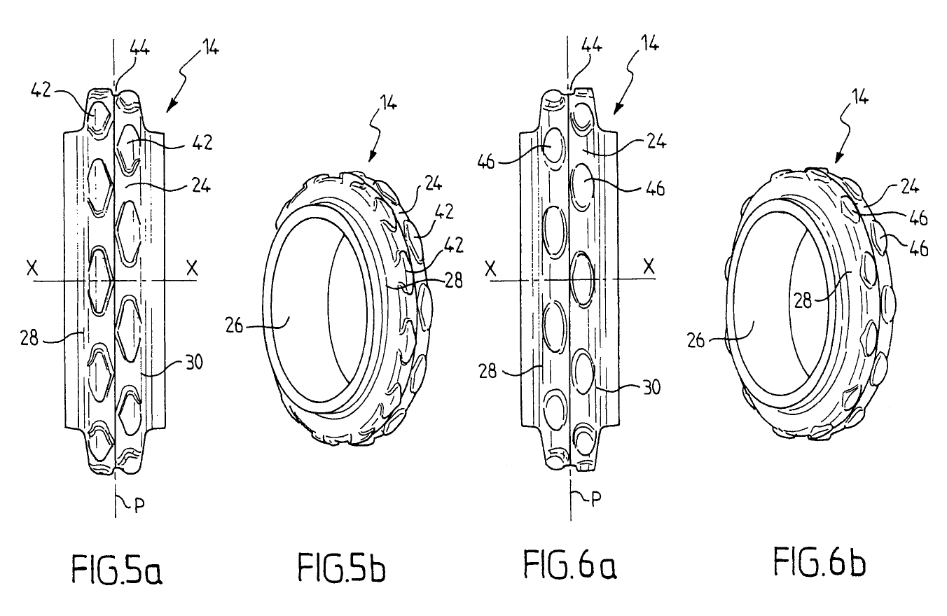

FIGS. 6a and 6b are similar to FIGS. 5a and 5b, showing a variant of the third embodiment.

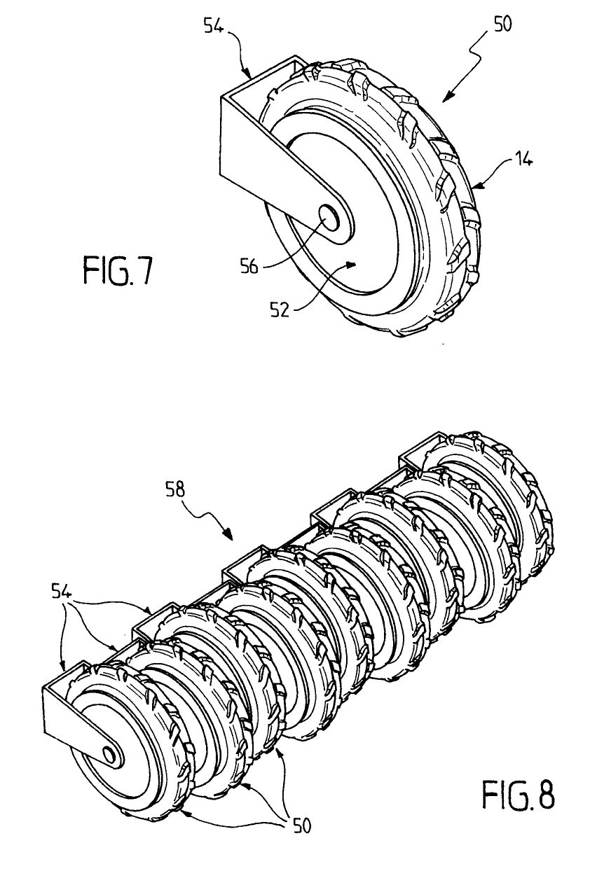

FIG. 7 is a perspective view of a wheel comprising a tyre according to the invention, and an associated wheel support.

FIG. 8 is a perspective view of an assembly formed from a plurality of wheels according to FIG. 7.

Reference will be made first of all to FIGS. 1, 2a and 2b which illustrate a tyre according to a first embodiment of the invention.

The tyre according to the invention is adapted to the construction of an agricultural roller 10, for example a roller for a seed drill, comprising a central tube 12 mounted to be rotatable about an axis X-X and on which are fitted a succession of similar tyres 14 (one of these tyres is shown on its own in FIGS. 2a and 2b).

The publication FR-A-2 841 733, in the name of the present Applicant, describes the method of producing a roller of this kind from a stack of tyres with a dome shaped profile. Essentially, these tyres are threaded on so as to be adjacent to one another and held at each end of the stack, for example by means of an end cheek 16 which clamps and holds the series of tyres.

It is also possible to assemble the tyres by their respective sidewalls forming contact areas and to use pushing means at the ends to form the assembly.

The various tyres in the stack may also be joined to one another by appropriate assembly means (not shown), such as those described in the publication FR-A-2 784 331 in the name of the present Applicant, to which reference may be made for more details.

The end cheek 16 bears against the last tyre 18 in the stack which as a result of this function may have a slightly different profile from the tyres 14, to enable it to fit into the cheek 14. The cheek is itself attached at 20 to the central tube 12. In this way, the stack of tyres and the tube form an integrated assembly which constitutes a roller capable of being mounted via a hub 22 on the support frame of an agricultural machine comprising other elements (seed drill, draw bar, etc) pulled along in a direction perpendicular to the axial direction X-X of the roller 10. The movement of the support frame, by the reaction of the tyres on the ground, causes the driven roller 10 to rotate.

The tyres create parallel furrows in the ground, in which seeds may be sown, for example. The spacing between the furrows corresponds to the gap between the treads of the adjacent tyres; in order to adjust this spacing, it may be possible to interpose intercalary annular elements between the adjacent tyres, the axial width of which will be selected as a function of the desired spacing of the furrows. The width of the furrows produced by the tyres may be selected as a function of the applications in order to allow, for example, a single line of sowing or at least two lines of sowing, for example.

The tyre suitable for the use mentioned above is of the general type described in the publication FR-A-2 763 279 mentioned in the introduction, i.e. wherein the part intended to make contact with the ground which is to be worked, or with the road surface, is a part forming a tread 24 with a dome shaped profile (rounded convex profile). This tread 24 is connected by two opposing sidewalls 28, 30 to a widened part 26 forming a sleeve adapted to be threaded onto the tube 12.

The two sidewalls 28, 30 define, inside the tyre, an annular space 32 of reduced cross section relative to the cross section of the overall dome shaped profile of the tyre. This hollow annual space 32 is not inflated and is able to communicate with the ambient surroundings via an opening passing through the thickness of the sleeve 26 (this opening, not shown, apart from allowing pressure equalisation during use, serves for the injection of air under pressure during the vulcanisation step of the manufacture of a tyre). In fact it is desirable that the tyre should be able to deform to some extent in the region between the tread 24 and the sleeve 26 to assist with detachment from the soil which otherwise would have a tendency to stick to the tyre in the region of the sidewalls 28, 30. This deformation of the tyre, which confers on it sufficient flexibility to attenuate the deformations and be self-cleaning, is nevertheless limited by the dome shape, which prevents the tread from being flattened excessively.

The central sleeve may be mechanically reinforced by one or more twisted cables or a retaining ring embedded in the material of the tyre, in particular in order to ensure better holding on the tube 12 in spite of the mechanical stresses to which the tyre is subjected, which may be fairly intense and severe, particularly on the road.

In a manner characteristic of the invention, the tyre 14 comprises, at the top of the tread 24, grippers such as 34, formed on the periphery of the tyre and distributed in the circumferential direction.

In a first embodiment shown in FIGS. 1, 2a and 2b, these grippers are arranged obliquely, i.e. they form an angle α (FIG. 2a) of the order of 30° to 45°, in one direction and the other, alternately.

The grippers 34 in this embodiment are each designed to extend into a half-space defined by the median plane P, alternately on one side and then the other of this plane P, the grippers furthermore being circumferentially offset from one gripper to the next.

This arrangement, as shown in FIGS. 1, 2a and 2b, gives a configuration of offset half-chevrons oriented in the direction of rotation of the tyre.

In an alternative embodiment shown in FIGS. 3a and 3b, the grippers 36 are similar to the grippers 34 in the previous embodiment, except that in the circumferential direction they are not offset from one gripper to the next, thus giving a configuration of whole chevrons, i.e. V shaped with two adjacent symmetrical branches extending on either side of the median plane P and joining level with this plane.

In a second embodiment shown in FIGS. 4a and 4b, the grippers 38 are circumferentially offset relative to the median plane P (as is the case in FIGS. 2a and 2b), but they do not extend as far as the median plane P and therefore leave a smooth gap 40 between the two rows of grippers 38 at the top of the tread 24.

It will also be noted that, in this latter embodiment, the length of the grippers 38, viewed in the circumferential direction, is greater than their width, viewed between their end closest to the top of the sidewall 28′ or 30 and their end closest to the median plane P, contrary to the embodiment in FIGS. 2a and 2b and 3a and 3b.

FIGS. 5a and 5b show a third embodiment in which the grippers 42 are roughly lozenge-shaped. The short axis of the lozenge extends roughly from the top of the sidewall 28 or 30 to the median plane P. The grippers 42 are offset in the circumferential direction from one gripper to the next, leaving a smooth zone 44 at the top of the tread, this zone not being straight as in FIGS. 4a and 4b, but zigzag shaped.

In this embodiment the shape of the grippers means that the tyre can be fitted in either direction, as desired, and/or used in both directions of rotation, unlike in the previous embodiments.

FIGS. 6a and 6b show a variation on the previous embodiment in which the grippers 46 are substantially arranged in the same way but are oblong in shape, in contrast to the lozenge shape of the grippers 42 in FIGS. 5a and 5b. This more rounded oblong shape allows the soil to come away more easily on heavy ground.

It will be noted that in all the embodiments shown the sidewalls 28, 30 are free from grippers: in fact the grippers 34, 36, 38, 42 or 46 extend only over the tread 24, starting from the top of the sidewalls. Consequently, the grippers do not project relative to the sidewalls and therefore do not interfere with the action of the scrapers usually present on agricultural machinery using these tyres.

FIG. 7 is a perspective view of a wheel 50 comprising a rim 52, made in one or more parts, on which is mounted a tyre 14 according to the invention. The wheel 50 is carried by a support 54 in the shape of a bracket via a pivot 56.

FIG. 8 shows how a plurality of wheels 50 with their respective supports 54, nine in this embodiment, may be grouped to form an assembly 58 which resembles a roller but in which the individual wheels are independent. The supports 54 of the wheels are offset two by two in order to avoid a coaxial arrangement of the wheels 50. The supports 54 may be mounted, for example, on respective independent arms (not shown) to enable the wheels to better follow the irregularities in the ground over which they are travelling.

The tyre according to the invention may be manufactured using the same manufacturing methods as those of semi-hollow tyres with a smooth surface. Essentially, the process consists in producing a hollow extruded profile of elastomeric material and cutting out a section of this profile. The ends of this section are joined together to form a circular element, then this circular element is placed in a mould and vulcanised in conventional manner to produce the finished tyre.

1. Pneumatic tyre (14) of the semi-hollow type for an agricultural machine, notably for a machine comprising a roller equipped with a series of tyres mounted on a horizontal tube (12), this tyre comprising a central sleeve (26) and at least one tread section with a dome shaped profile, comprising a tread (24) attached to the sleeve (26) by two sidewalls (28, 30) so as to define a hollow annular space (32) of reduced cross section compared with the cross section of the dome shaped profile, characterised in that it comprises a plurality of peripheral grippers (34; 36; 38; 42; 46) formed to project from the tread (24) and distributed in the circumferential direction at the top of the dome shaped profile.

2. Tyre according to claim 1, characterised in that the grippers (34; 36; 38; 42; 46) are disposed on the tread on either side of the median plane (P) of the tyre.

3. Tyre according to claim 1, characterised in that the grippers (34; 36; 38; 42; 46) extend, in the axial direction, from the top of the sidewalls (28, 30) towards the median plane (P) of the tyre, without projecting axially from the surface of these sidewalls.

4. Tyre according to claim 1, characterised in that at least some of the grippers (34; 36; 38) extend to a greater extent forming an angle (α) relative to the axis (X-X) of the tyre.

5. Tyre according to claim 4, characterised in that the width of the grippers (34; 36), measured between their end closest to the top of the sidewall and their end closest to the median plane (P) of the tyre, is greater than their length, measured in the circumferential direction.

6. Tyre according to claim 5, characterised in that the grippers are in the form of chevrons (36) or half chevrons (34) extending axially to the level of the median plane (P) of the tyre.

7. Tyre according to claim 2, characterised in that the grippers (36) are disposed symmetrically on either side of the median plane (P) of the tyre.

8. Tyre according to claim 2, characterised in that the grippers (34; 38; 42; 46) are arranged alternately on either side of the median plane (P) of the tyre, with one gripper being offset from the next in the circumferential direction.

9. Tyre according to claim 2, characterised in that the grippers (38) do not extend in the axial direction as far as the level of the median plane (P) of the tyre, so as to leave between them a gap (40) at the top of the tread.

10. Tyre according to claim 2, characterised in that the grippers (42) are generally lozenge shaped.

11. Tyre according to claim 2, characterised in that the grippers (46) are generally oblong in shape.

12. Tyre according to claim 10 or 11, characterised in that the short axis of the lozenge or of the oblong contour extends generally from the top of the sidewall to the median plan (P) of the tyre.

13. Tyre according to claim 10 or 11, characterised in that the lozenges or the oblong contours are disposed alternately on one side and the other of the median plan (P) of the tyre with offsetting of one gripper from the next in the circumferential direction.

14. Tyre according to claim 9, 10 or 11, characterised in that the length of the grippers (38; 42; 46) viewed in the circumferential direction, is greater than their width, measured between their end closest to the top of the sidewall and their end closest to the median plane (P) of the tyre.

15. Roller (10) comprising a plurality of tyres (14) according to one of claims 1 to 14.

16. Wheel (50) comprising a tyre (14) according to one of claims 1 to 14.
